(19) United States
(12) Patent Application Publication
(10) Pub. No.: US 2013/0145704 A1
(43) Pub. Date: Jun. 13, 2013

(54) WINDOW INSTALLATION ASSEMBLY AND METHOD TO INSTALL WINDOWS

(71) Applicant: William E. Stein, JR., Harleysville, PA (US)

(72) Inventor: William E. Stein, JR., Harleysville, PA (US)

(21) Appl. No.: 13/324,134

(22) Filed: Dec. 13, 2011

(51) Int. Cl. E06B 1/60; E06B 1/56; E06B 1/00; E06B 1/36

(52) U.S. Cl. 52/204.1; 52/656.5; 52/656.9; 52/745.15

(57) ABSTRACT

A device is provided to improve the installation of a window frame within a window opening comprising a clip, a track, a base plate, and an elevator attachment. The device of the invention and the method of utilizing the device improve the efficiency and effectiveness of current installation methods by providing rapid installation of a frame that is centered and true and additionally vertically adjustable via an elevator attachment.

### FIELD OF THE INVENTION

The present inventive concept provides a window frame clip for assisting the installation of windows in a building, and a method for installing the window frame clip into a track. The clip and track reduce the amount of skilled labor required to correctly install window framing and for window glass installation.

### BACKGROUND

The present inventive concept relates to a device and method to install windows in the wall of a building. For large windows, the frame is typically prefabricated at another location and erected and attached to the structure onsite. The metal forming the frames can be extruded in mass quantities, creating numerous frame pieces at one time, reducing the manufacturing costs. Installation is performed at the job site where a sill is installed in the interior of the rough window opening and then the frame pieces are installed to meet the sill and the rough window opening. After the frame is attached to the building in the rough opening, the glass is inserted and sealed in place.

The existing method of window installation requires extensive skilled labor to install prefabricated frame pieces into existing window openings. Typically, a new building will have rough openings that are constructed to receive a window installation. These rough openings are made of building materials and have some deviation as to the dimensions. When replacement windows are installed, the window, sill, frame and glass are removed and replaced. In typical commercial buildings, in each window opening, a sub sill is installed at the bottom of the rough opening. Shims are used to level the sub sill and compensate for any unevenness in the rough opening bottom. The window frame is installed in the rough opening, and again, shims are used to compensate for any unevenness in the top of the rough window opening. The window frame must be vertically aligned to be positioned directly above the sub sill. Extensive time and labor is required to ensure that the window frame is true and square prior to installation of the window glass. After installing the frame in the rough opening and ensuring that it is true and square, the glass is installed into the frame. The glass is typically retained within the frame with the use of a waterproof gasket through friction fit. The frame must be level and plumb to the building or the glass cannot be inserted properly.

Typical installation process includes a frame that is placed on the sub sill and then wedged into position with shims so it does not fall out of the opening. In the installation of multiple adjacent windows, any adjacent window frames are installed next to the previous frame until all the frames are in position and locked together with fasteners. Then the window frames can be plumbed left to right and in and out of the building's rough opening. The connection between the frame and the building is typically conducted with standard fasteners such as screws. After the frame is in place in the correct position it can be fastened to the building with the proper fastener for the building material. If hard building materials are used such as concrete or steel, drilling through the top of the window frame is required. The material of the building structure can complicate the installation process. Hard structural materials require a large amount of force to penetrate with a fastener such as a screw or nail. This forceful penetration causes problems including causing the frame to move out of alignment. Further, use of a drill can cause debris from the window frame or building material to be created that then falls into the window glass pocket that will need to be cleaned out before glass is installed, prolonging the installation. In addition to the cleanup of the debris from the window frame, the forceful attachment of the window frame to the building can cause the frame pieces to shift as they are merely held in by shims and friction fit prior to the attachment. Thus, care and attention is required and owing to the size of the frame pieces that must be attached and the hardness of the material it is being attached to, attaching the window frame to the building requires extensive onsite effort. To ensure the track is installed correctly and that precision placement of the frame can occur, significant skilled labor is required during the installation.

Typical installation tolerances are plus or minus one quarter of an inch. The use of shims is common to adjust the vertical position of the window frame, relative to the sub sill. A laser or other leveling instruments are used to indicate true vertical from the sub sill and ensure that the window frame is plumb and centered in the rough opening. Variations in the rough opening are typically addressed by the use of additional shims. It is the transition from shims to permanent attachment of the window frame to the building structure that is time consuming and unreliable. This is a contribution to the cost of the installation.

The use of ad hoc adjustments requires additional skill and time, and can provide a less aesthetically pleasing finished window if not accomplished within fine tolerances. If leveling is not achieved, the window as visible from the exterior and interior of the building will not appear aesthetically pleasing and may not match the other windows of the building. Additionally, the position of the window too far into the building or too far out of the building window opening will not appear plumb and the surface of the window will not appear to be true vertical. Variations in the dimensions of the window installation may lead to water leakage and associated water damage.

Several attempts have been made to simplify the frame attachment and window installation process, but none have been successful in reducing the amount of time and skill necessary for the job to be completed properly. Specifically, the Kirk, et al. patent application (2007/0,144,106) discloses the use of a window frame clip that provides tabs to properly align a window frame. However, this clip piece does not allow the user to adjust the level of the frame in relation to the building. It merely provides a quick attachment of the window to the sill—at whatever height the sill occupies. It is not adjustable nor does it provide a height adjustment. It does not provide a centering function to ensure that the window is plumb relative to the sill. The use of the Kirk device does not increase the available tolerance on a track installation. The Kirk device does not reduce the requirement of skilled workers to install the window frame properly.

What is needed is an apparatus and a method for using such an apparatus that simplifies the installation of windows into a building and reduces the time and labor required to level and plumb a window installation. The apparatus should be simple to operate and attach the frame in the correct position for a glass panel to be inserted. The apparatus should reduce the amount of skilled labor needed to install a window properly.

### SUMMARY OF THE INVENTION

It is an aspect of the present inventive concept to provide for an improvement in window installation.

The above aspect can be obtained by a device for attaching a window frame to a window opening, comprising a window frame having an opening, a clip having a threaded opening, the clip positioned adjacent to the window frame; and an elevator attachment positioned through the window frame opening that threadedly engages the threaded opening, wherein the elevator attachment is configured to adjust a distance between the clip and the window frame by turning the elevator attachment.

### BRIEF DESCRIPTION OF THE DRAWINGS

Further features and advantages of the present device, as well as the structure and operation of various embodiments of the present device, will become apparent and more readily appreciated from the following description of the preferred embodiments, taken in conjunction with the accompanying drawings of which:

FIG. 1 is a perspective view of a clip, according to an embodiment;

FIG. 2 is a perspective view of a clip, frame, and elevator attachment according to an embodiment;

FIG. 3 is a perspective view of a base plate, according to an embodiment;

FIG. 4 is a side view of an angled clip, according to an embodiment.

FIG. 5 is a perspective view of a guide post, according to an embodiment;

FIG. 6 is a perspective view of a guide post, according to an embodiment;

FIG. 7 is an exploded view of an assembly, according to an embodiment;

FIG. 7A is an exploded view of an assembly, inverted from FIG. 7, according to an embodiment;

FIG. 8 is an exploded view of an assembly, according to an embodiment;

FIG. 9 is a side view of a frame and track, according to an embodiment.

FIG. 10 is a side view of an angled clip positioned within a track attached to a structure, according to an embodiment.

FIG. 11 is a perspective view of the angled track and building, according to an embodiment;

FIG. 12 is a perspective view of a threaded insert, according to an embodiment.

FIG. 13 is a perspective view of a window frame comprising a thermal break and an offset base plate, according to an embodiment.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Reference will now be made in detail to the presently preferred embodiments of the inventive concept, examples of which are illustrated in the accompanying drawings, wherein like reference numerals refer to like elements throughout. It is known to install a window frame in a rough window opening in a building or other structure. The window frame is constructed to receive a window pane of glass or other transparent or translucent material. The inventive concept relates to an improved device and method of adjustably attaching a window frame to a track using a clip. One existing method is to use a drill and a screw to attach the frame to the building. Existing window installations are primarily made of extruded aluminum. Modern high rise buildings have exteriors that are mostly glass panels. In some construction, the exterior of the building is a sequence of windows. Extruded aluminum can be fabricated in sections with each section preferably being sized to fit the window opening. Window dimensions can range from several inches to in height and width to ten feet or more in height and width. Window size is limited by the material strength and expected stresses including wind force. Indoor window panels are subject to less force than outdoor panels or exterior windows. Tracks made of aluminum are light and easy to work with. The inventive concept can be practiced with any common construction material including metals and plastics. Reference will be made to aluminum as it is the most common window installation material; however, the inventive concept is not limited to aluminum and will function with parts made of any other structural material including other metals or plastics. Each track is individually attached to the building and is required to be leveled and attached to the hard building material. Common fasteners are used including nails and screws. Percussive nail guns or pneumatic attachment methods can also be employed. The inventive concept contemplates that a window frame will be pre drilled to receive an adjustable attachment device or elevator attachment for connection to a clip. In another embodiment a window frame top is pre drilled with three holes, a left opening, a central opening, and a right opening. It is contemplated that the same process can be employed on both the left and right sides of a window frame to effect installation. For clarity and brevity in this description, one side of the window frame installation will be discussed.

Because gravity will push a window frame towards the bottom of a window opening, it is advantageous to deal with the extra space between the window frame and the window opening that exists at the top of the window. Therefore, it is assumed that the window frame will sit at rest at the bottom of the window opening and will be secured using the space at the top. This invention could be practiced up, down, left, or right, but for practical purposes, the most efficient approach is to place a window frame on a window sill and then address the spacing that is at the top of the window opening. The window frame is preferably attached to a base plate and a clip. The inventive concept can be practiced without a base plate, but a base plate adds stability to the inventive concept. The central opening in the frame allows access to the elevator attachment device. In one embodiment, the elevator attachment is a screw. The base plate left and base plate right openings are used to attach the base plate to the window frame using at least one mounting attachment. In one embodiment of the inventive concept the mounting attachment is a screw. In an embodiment, the mounting attachment further engages a guide post that traverses an opening in the clip and is friction fitted to the base plate.

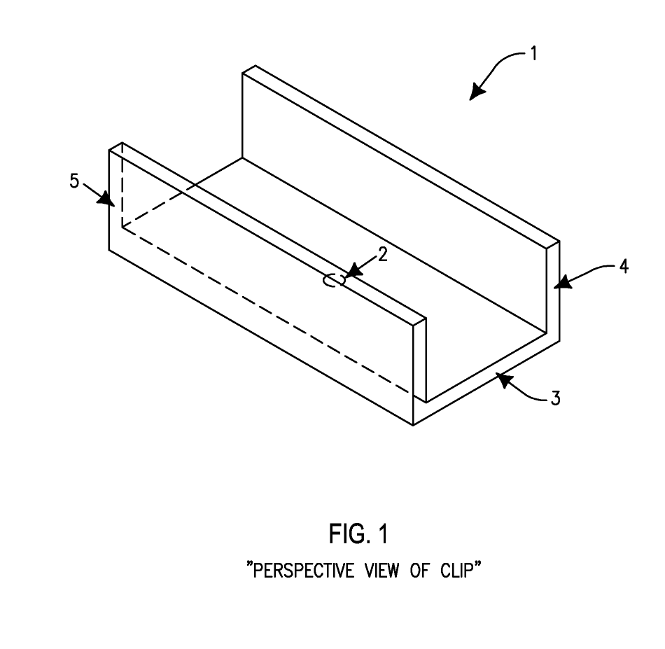

The present inventive concept provides a method and device for installing windows in a building or structure. FIG. 1 shows an embodiment of the clip 1. The clip 1 is configured in a U shape having a convenient length preferably between one and 12 inches and most preferably four inches. The clip is composed of rear wall 4, bottom wall 3 and front wall 5. Disposed approximately centrally in the bottom wall 3 is a threaded opening 2.

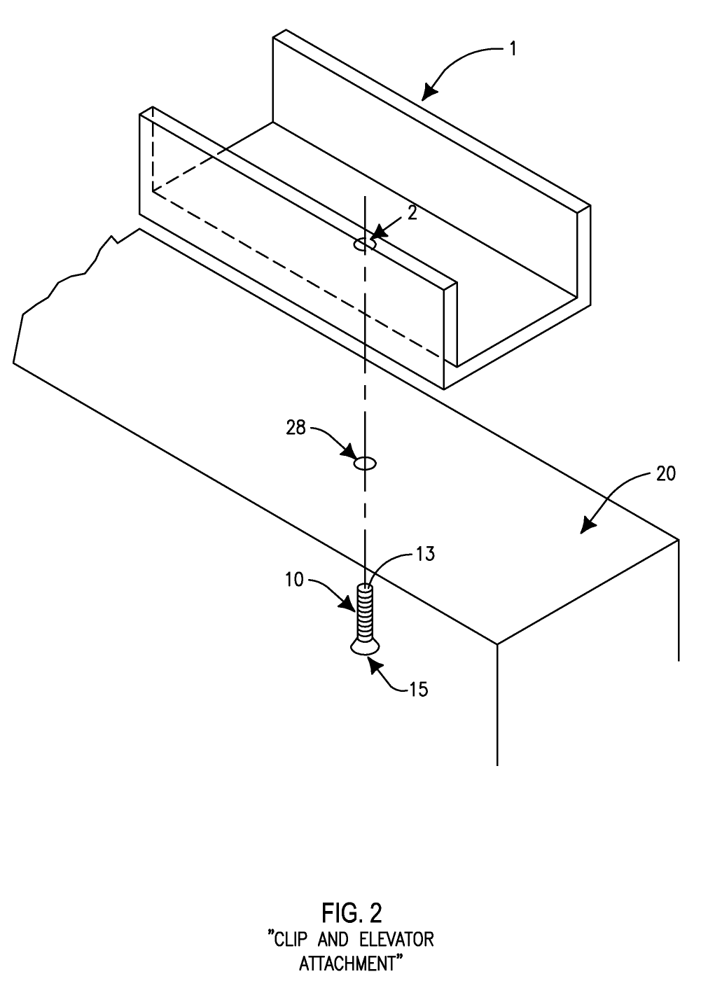

FIG. 2 presents an exploded view of a clip, frame, and elevator attachment according to an embodiment. The attachment of a window frame 20 to the clip 1 is accomplished by means of the elevator attachment 10. A window frame 20 having a smooth opening 28 can be joined to the clip 1 by means of the elevator attachment 10. The smooth opening 28 does not engage the threads of the elevator attachment 10 allowing the elevator attachment to travel within smooth opening 28. The elevator attachment top 15 has an enlarged head possessing a diameter greater than the diameter of smooth opening 28. This geometry prevents the elevator attachment 10 from passing completely through the smooth opening 28. In order to attach the frame 20 to the clip 1, the elevator attachment 10 is passed through the smooth opening 28 and engages the threaded opening 2. In this way, the elevator attachment 10 dictates the maximum distance between the window frame 20 and the clip 1. Using a conventional threaded attachment for the elevator attachment 10 such as a Phillips head machine screw, turning the elevator attachment 10 clockwise and holding the frame 20 steady will cause the elevator attachment 10 to travel into threaded opening 2 and draw the clip 1 towards the frame 20. In a method of using the inventive concept, distal end 13 of the elevator attachment 10 is passed through smooth opening 28 of window frame 20 and threadedly engaged in threaded opening 2. The elevator attachment 10 is turned clockwise to draw the clip 1 closer to window frame 20. During installation of frame 20 into a track not shown, elevator attachment 10 can be turned counterclockwise to extend clip 1 away from frame 20. In this way clip 1 will engage the track (not shown) or other typical window installation components. The embodiment shown in FIG. 2 dictates the maximum distance between the clip 1 and the frame 20, but does not determine a minimum distance. The minimum distance is not fixed because the elevator attachment 10 can slide through smooth opening 28. The maximum separation is fixed because 15 is larger in diameter than 28. Installation of this clip 1 into a track (not shown) will center the frame 20 in the window opening and ensure that the window assembly stays centered. Further adjustment of elevator attachment 10 will set the vertical position of the frame 20 relative to the track (not shown).

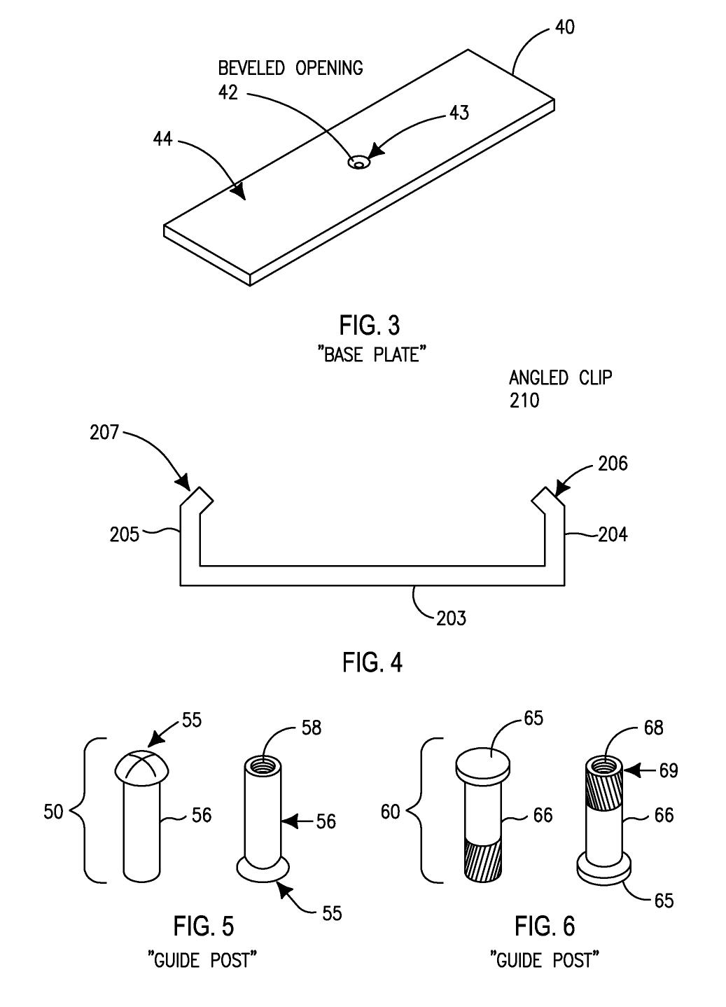

It is a further aspect of this inventive concept to provide a device that determines a fixed separation between the clip 1 and the frame 20. FIG. 3 presents an embodiment of the inventive concept further comprising a base plate 40. The base plate 40 is preferably rectangular in shape and having a convenient length of ½″ to 12″ and complimentary to the length of the clip and a width preferably less than the width of the window frame. In a preferred embodiment the base plate is four inches in length. Centrally disposed in the base plate 40 is opening 42 that is smooth and not threaded. The size of the opening 42 corresponds to the size of opening 28 in FIG. 2 and is suited to receive elevator attachment 10. Base plate bottom 44 includes a bevel 43 about opening 42. The bevel side of the opening has a maximum diameter equivalent to the diameter of elevator attachment top 15 so that 15 can be fully recessed within the bevel 43 of base plate 40. In one embodiment opening 42 is 0.28″ in diameter while bevel 43 ranges from 0.28″ to 0.375″.

FIG. 4 presents a side view of an angled clip. Angled clip 210 is formed with a bottom wall 203, rear wall 204, and front wall 205. Rear centering angle 206 is disposed at the top of rear wall 204 and angled inward. Front centering angle 207 is disposed at the top of front wall 205 and also angled inward. In a preferred embodiment front centering angle 207 is 45 degrees, and rear centering angle 206 is 45 degrees. Any acute angle will provide the benefit of aiding the clip 210 in entering the interior of a track. In a preferred embodiment, clip bottom wall is 2 7/16 inches wide, the clip is 4 inches in length, front wall 205 and rear wall 204 can be any convenient height, but preferably ¼ to 6 inches high and most preferably ½ inch high. Both centering angles preferably protrude ⅛ of an inch from corresponding walls.

FIG. 5 presents perspective views of guide post 50. The guide post head 55 is wider than the guide post body 56 and has an interior threaded opening 58. Guide post 50 can be created by machining out the bottom of a smooth bolt and creating the threaded opening 58.

FIG. 6 presents an improved guide post 60. Guide post 60 has a smooth circular head 65 attached to a guide post body 66. The end opposite the head 65 is machined to create an interior threaded opening 68 within distal end 69. Distal end 69 is embossed to create a series of exterior grooves to prevent rotation of guide post 60 when compression fit into a base plate not shown. In a preferred embodiment guide post body 66 is approximately ¼ inch in diameter.

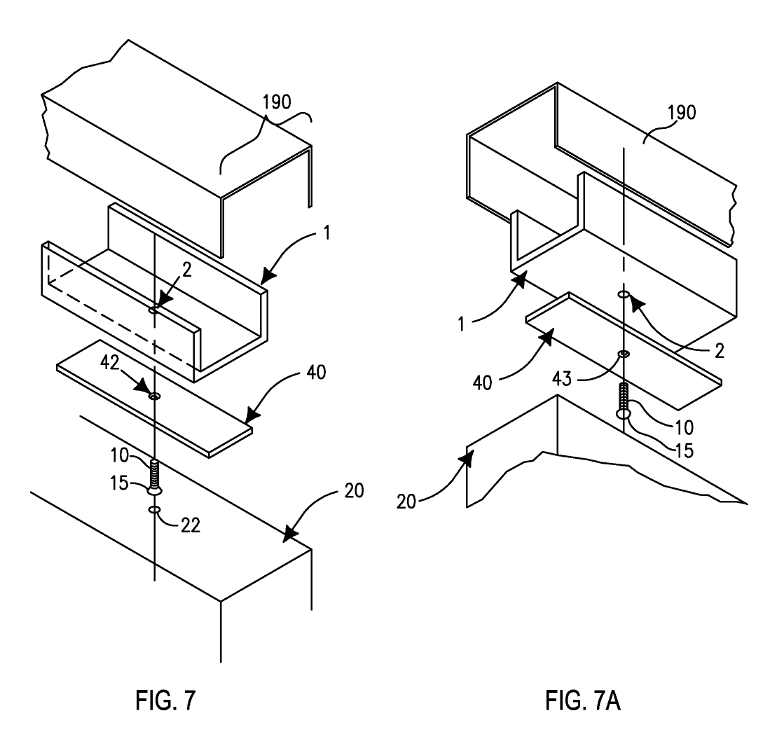

FIG. 7 presents an exploded view of an embodiment of the inventive concept utilizing base plate 40 to determine a fixed separation between window frame 20 and clip 1. Elevator attachment 10 is passed through smooth opening 42 of base plate 40 and elevator attachment top 15 is recessed within beveled opening 43 (not shown). A corresponding hole is created in window frame 20 to create access hole 22. The base plate 40 containing elevator attachment 10 is then joined or married to the window frame 20 by adhesive attachment or welded attachment so that beveled opening 43 is situated above access hole 22 and the elevator attachment top 15 is accessible through access hole 22. “Married” within this disclosure is intended to mean joined or attached in a manner that will not separate. In this embodiment, elevator attachment 10 does not pass through window frame 20 or access hole 22, but is accessible through 22. The opening 22 disposed in the window frame 20 is aligned with the top 15 of the threaded elevator attachment 10. Opening 22 is smaller in diameter than the enlarged head of the elevator attachment top 15 to prevent passage of the elevator attachment top 15 though the opening 22. Turning elevator attachment 10 engaged with the threaded opening 2 in clip 1 operates to increase or decrease the distance between base plate 40 and clip 1. Since base plate 40 and frame 20 are married, this also increases or decreases the distance between the frame 20 and the clip 1. In this way the clip 1 can be used to engage the track 190 and dictate the position of the window frame 20 relative to track 190, namely centering the frame 20 within the track 190 to fix the position of the window frame 20 in and out of the window rough opening. Assuming elevator attachment 10 is conventionally threaded; turning elevator attachment 10 counterclockwise will withdraw the elevator attachment top 15 relative to the threaded opening 2. The effect is to raise the clip 1 into the interior of the track 190. The clip 1 is sized to friction fit within the track. This attachment is very fast and can be accomplished with a screw gun or other power tool. The geometry of the inventive concept dictates that once the clip 1 is seated within the track 190, it will be plumb in and out of the plane of the window opening and necessarily centered within the track 190. Fine adjustment of the elevator attachment 10 can provide additional fine adjustment of the frame height or the position of frame 20 relative to track 190. By turning the elevator attachment 10, the distance between the clip 1 and the frame 20 can be increased or decreased. This fine adjustment can compensate for small changes in the position of the track 190 relative to true level. Small deviations from level can be accommodated with a turn of elevator attachment 10.

FIG. 7A presents and inverted view of the elements of FIG. 7. From the underside of the elements, bevel 43 can be seen in base plate 40. Elevator attachment top 15 is sized corresponding to bevel 43 so that it is seated flush within base plate 40.

It is a further aspect of the inventive concept to provide a clip 1 that does not spin relative to the frame 20 when the elevator attachment 10 is turned.

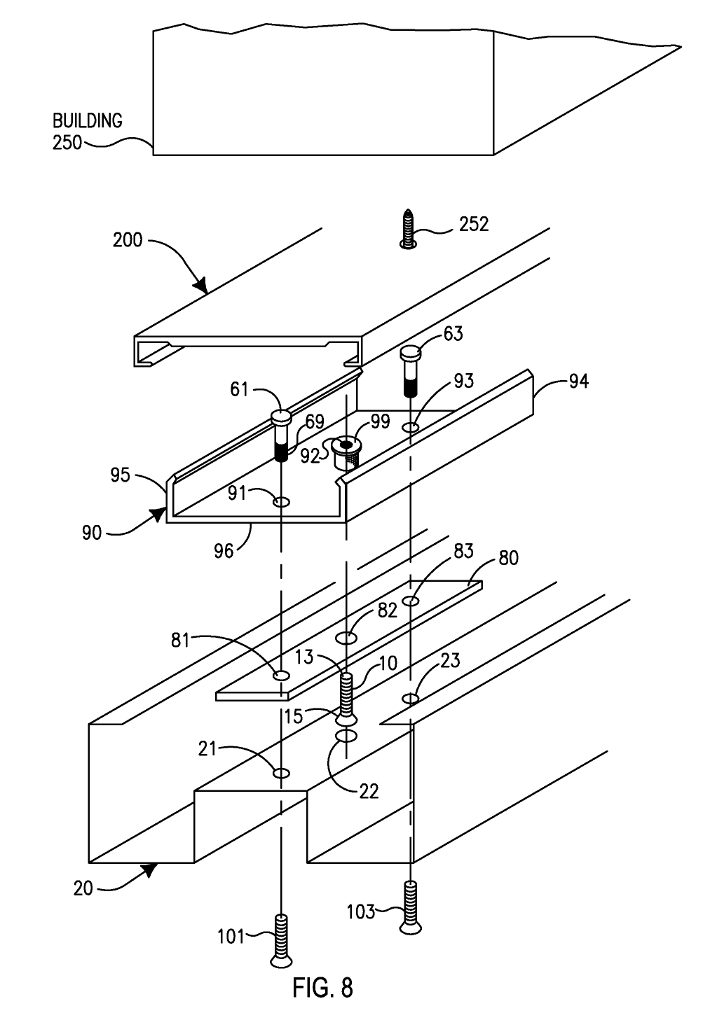

It is advantageous to provide additional features to ensure the optimal positioning, adjustment, and function of the inventive concept. The addition of guide posts and mounting attachments provide added stability and resistance to twisting of the clip. FIG. 8 presents a base plate 80 and angled clip 90 for use with a guide post. In one particular embodiment, the base plate is ¾ of an inch wide, 3/16 of an inch thick and 4 inches long. In a preferred embodiment, the central smooth opening 82 is approximately 0.280 inches in diameter and base plate left opening 81 and base plate right opening 83 are both approximately 0.22 inches in diameter. In a preferred embodiment, a first guide post 61 is slidably engaged with angled clip 90 by passing through clip left opening 91 and fixed to the base plate 80 by compression fit into base plate left opening 81. Clip left opening 91 can be approximately 0.280 inches to accommodate a guide post 61 with a body width of 0.25 inches. Embossed distal end 69 prevents rotation after compression fit. A second guide post 63 is slidably engaged with the angled clip 90 by passing through clip right opening 93 and fixed to the base plate 80 by compression fit into base plate right opening 83. Elevator attachment 10 is passed through central smooth opening 82, preferably ⅜ inches wide, to engage central threaded opening 92. In this embodiment central threaded opening 92 is created by press fitting a threaded insert 99 into an opening centrally disposed in clip bottom wall 96. The threaded insert preferably has ⅜″ of interior threaded connection and a knurled exterior to increase friction fit as well as a rim about the base. Other methods of creating central threaded opening 92 are available and within the scope of the invention. A threaded insert provides more stability than merely machining threads into an opening in the base plate, but machining threads, and other methods would function within the scope of the invention. Clip front wall 94 and clip rear wall 95 are spaced to fit within a track, preferably two inches to six inches apart. Elevator attachment 10 is inserted in central opening 82 and seated flush. Central smooth opening 82 is surrounded by a bevel not shown to enable elevator attachment 10 to be seated flush. The distal end 13 of elevator attachment 10 is threadedly engaged with central threaded opening 92. In a preferred method of installation, the elevator attachment 10 is turned clockwise to draw the clip 90 towards the base plate 80. The clip 90 and base plate 80 are then attached to the frame 20. Frame 20 is prepared with three holes corresponding to the openings in the base plate 80 and the clip 90. The distance between frame left opening 21 and frame central opening 22 must be equivalent to the distance between base plate left opening 81 and central smooth opening 82 which in turn must be equivalent to the distance between clip left opening 91 and central threaded opening 92 to ensure that the inventive concept functions properly. Similarly, the distance between frame central opening 22 and frame right opening 23 should be equivalent to the distance between central smooth opening 82 and base plate right opening 83 which in turn should be equivalent to the distance between central threaded opening 92 and clip right opening 93 in order for the inventive concept to function properly. It should be noted that the inventive concept functions with one guide post, but the use of two guide posts confers added stability and ease of use. Mounting attachments 101 and 103 are passed through openings 21 and 23 respectively and threadedly attached to the interior threaded openings of guide posts 61 and 63 respectively thereby fixing the rotational alignment of clip 90 and base plate 80 relative to window frame 20. Mounting attachment 101 and mounting attachment 103 ensure that base plate 80 is affixed to frame 20 and does not separate, effectively marrying base plate 80 to frame 20 by threaded fasteners. Accessing elevator attachment 10 through frame central opening 22 and adjusting elevator attachment 10 by turning will increase or decrease the spacing between base plate 80 and clip 90. Frame central opening need not be centrally disposed and the location of each opening is listed and named for clarity but does not limit the invention. Openings left, right, and central could be switched and the invention would still function in the same manner. Angled track 200 is contemplated as being installed in a rough window opening. The window frame 20 is centrally installed within angled track by positioning the window frame 20 under angled track 200 and adjusting the elevator attachment 10 to increase the distance between the clip 90 and the base plate 80. Increasing this separation between base plate 80 and clip 90 effects an extension of the clip 90 upwards and away from the frame 20 so that it engages angled track 200 in friction fit. A manner of utilizing the inventive concept is displayed in FIG. 8. Angled track 200 is installed in a window opening by attachment to building structure 250 with at least one fastener 252. Threaded insert 99 is press fit into clip central opening to create threaded opening 92. A base plate 80 (which is illustrated as being rectangular, although other shapes can be used) is formed of a structural material, preferably aluminum. Base plate 80 features three openings 81, 82, 83 spaced apart with distances corresponding to openings 91, 92, 93 in the angled clip 90. A guide post 61 is passed though clip left opening 91 and compression fit into the base plate 80 left opening 81. Similarly, guide post 63 is passed though clip right opening 93 and compression fit into the base plate right opening 83. These guide posts 61, 63 prevent the clip 90 from rotating relative to base plate 80. Further, the tops of the guide posts 61, 63 fix the maximum separation distance between the angled clip 90 and the base plate 80. Elevator attachment 10 is passed through central opening 82 (which can be beveled) to engage central threaded opening 92. Mounting attachment 101 (illustrated as a screw) is passed through frame left opening 21 to engage the threaded opening of guide post 61. Mounting attachment 103 (shown as a screw) is passed through frame right opening 23 to engage the threaded opening of guide post 63. When the mounting screws are tightened, base plate 80 is married to window frame 20. Angled clip 90 can now be adjusted relative to the frame 20 by turning elevator attachment 10 which can be accessed though access hole 22. Preferably, elevator attachment 10 is turned clockwise to bring the clip 90 close to the window frame 20. These proceeding assembly steps can be performed prior to installation of the window sub sill not shown and angled track 200 for convenience or attached at the time of installation. After angled track 200 has been attached to building structure 250, window frame 20 is then installed to angled track 200 by way of clip 90 by positioning the frame 20 below and central to angled track 200 and using the elevator attachment 10 to increase the distance between clip 90 and frame 20. Where elevator attachment 10 is a conventionally threaded screw, this is accomplished by turning the screw counterclockwise. Increasing the separation between clip 90 and frame 20 effectively pushes angled clip 90 into the interior of angled track 200.

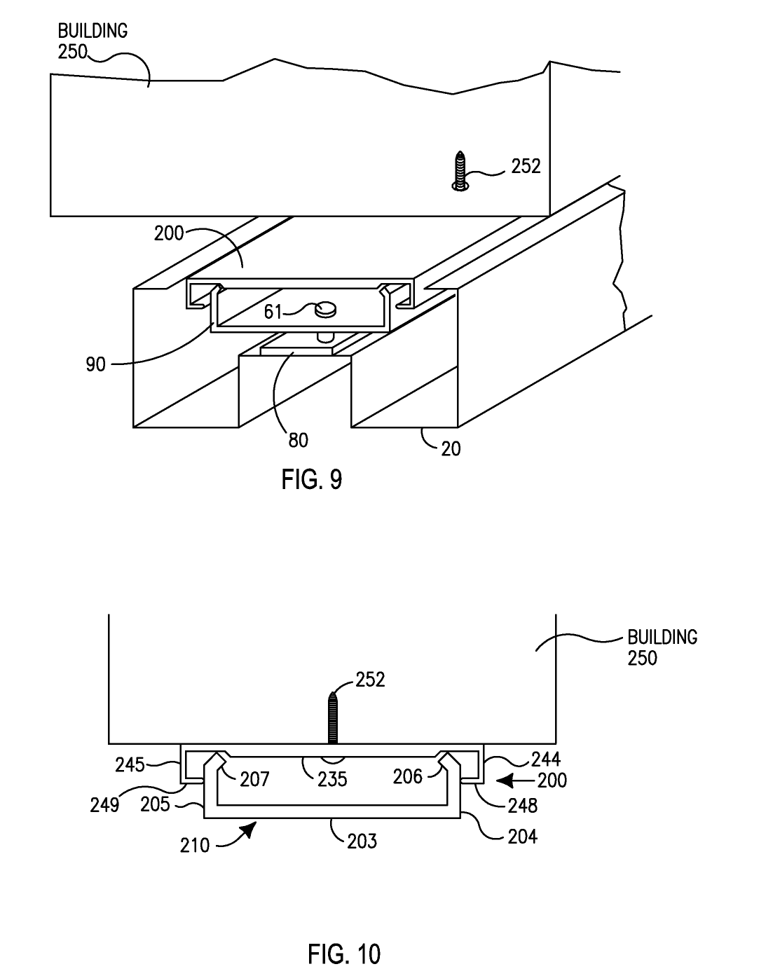

FIG. 9 shows a perspective view of an embodiment of the inventive concept installed in a window opening. The elements previously presented in FIG. 8 are shown here as installed and fit together. Frame 20 is attached to base plate 80 and angled clip 90 is centered by guide post 61 to the interior of angled track 200. Building structure 250 is shown above the elements of the inventive concept. Fastener 252 connects track 20 to building structure 250.

FIG. 10 presents a side view of an embodiment of an angled clip 210 and an angled track 200. Angled clip 210 is shown with bottom wall 203, rear wall 204, and front wall 205. Rear centering angle 206 is positioned within track rear wall 244. Front centering angle 207 is positioned within track front wall 245. Each of the centering angles on the angled clip 203 helps the clip to be positioned in the interior of the track 200 when it is raised vertically to encounter the track 200. Track raised section 235 runs centrally through track 200 and provides additional thickness and strength to receive various fasteners 252. Fastener 252 is shown attaching track 200 to building structure 250. Fastener 252 is shown as a screw, but can also be a nail, anchor, bolt, or other known fastener applied with torque, impact, or other method to attach angled track 200 to building structure 250. Track raised section 235 is of a width sufficient to avoid obstructing rear centering angle 206 or front centering angle 207.

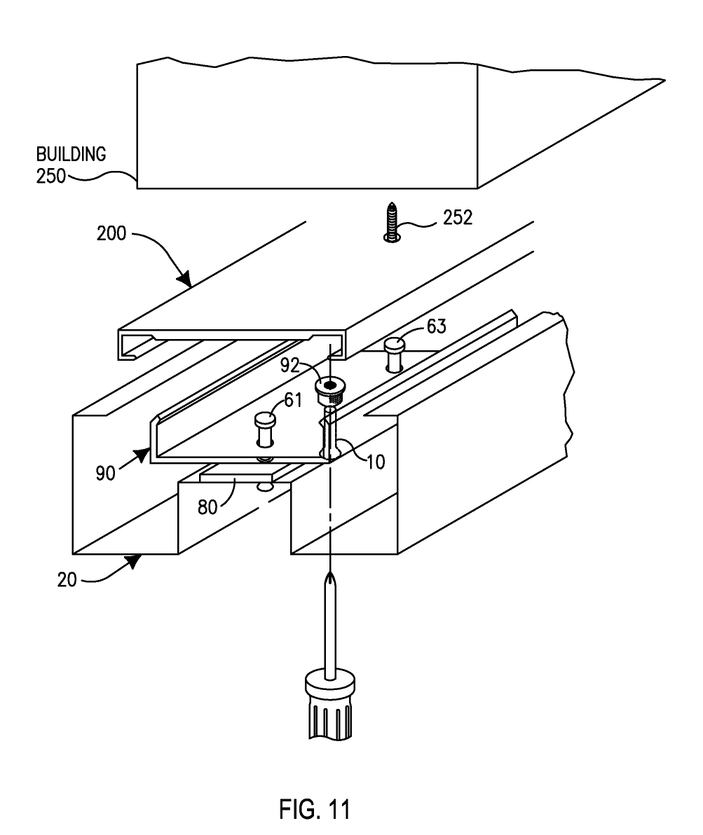

FIG. 11 shows the angled track and building, according to an embodiment. Angled track 200 is attached to building structure 250 by fastener 252, shown here as a screw. Frame 20 is attached to base plate 80. Guide posts 61 and 63 retain and orient angled clip 90. Frame 20 is held while elevator attachment 10 is turned clockwise to engage threaded opening 92 and draw angled clip 90 toward the frame 20. This provides more space for installation. It is conventional that this space will be above the window frame vertically, but this invention can be practiced in any direction. The connected elements clip 90, base plate 80, and frame 20 are then positioned under angled track 200 and elevator attachment 10 is turned counterclockwise to position the angled clip 90 within angled track 200. Turning elevator attachment 10 in this manner expands the clip 90 away from frame 20 and tightens the parts for a secure installation. Elevator attachment 10 is recessed and does not interfere with the installation of a glass window not shown. This installation process has a minimal increase in material cost, but provides a large decrease in the cost of labor for installation.

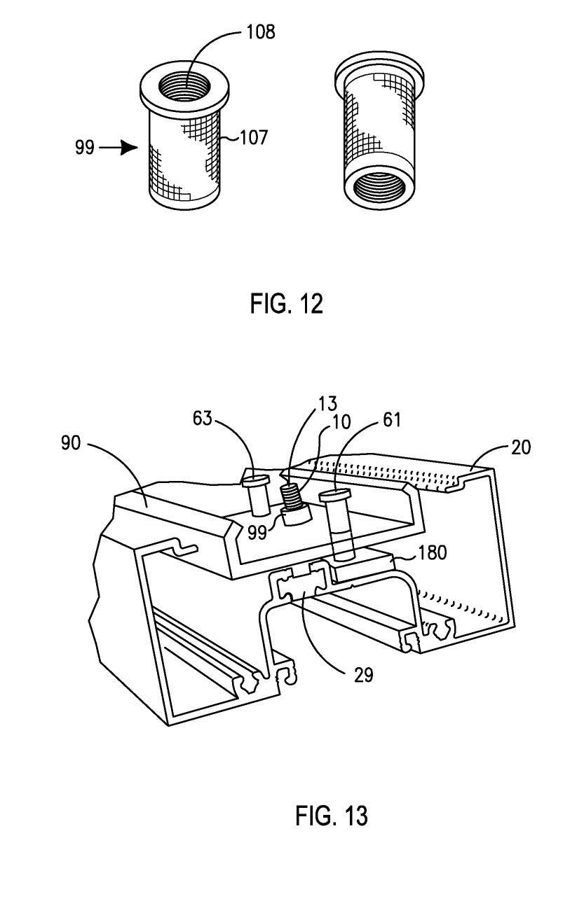

FIG. 12 shows two perspective views of a threaded insert. Threaded insert 99 has a knarled exterior 107 and a threaded interior 108.

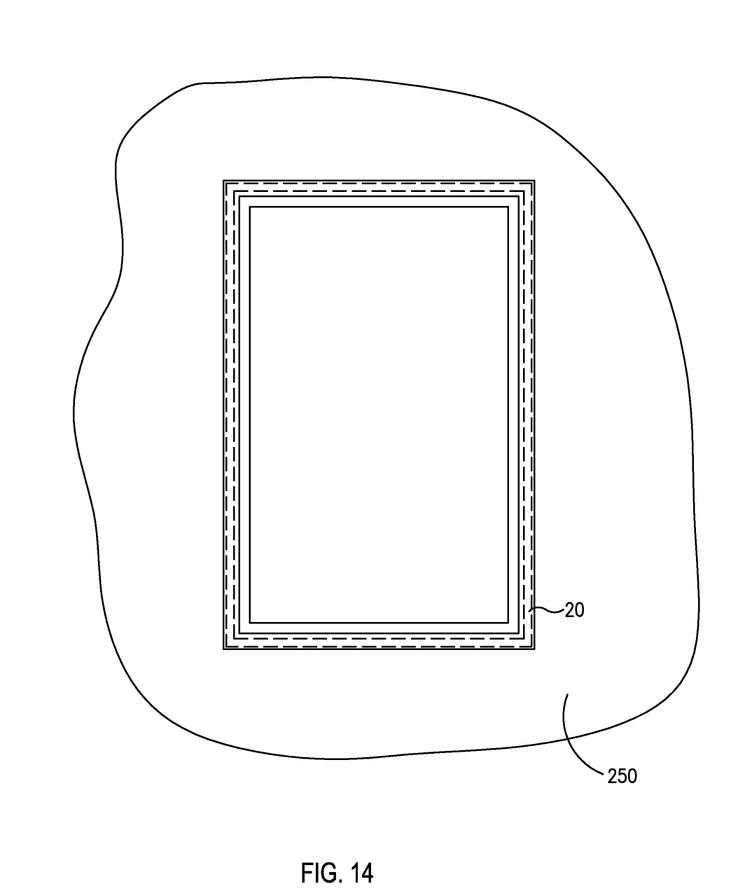

FIG. 13 shows an embodiment of the inventive concept to accommodate a thermal break. Because aluminum is a conductor, it is advantageous to prevent the conduction of heat or cold through the window frame. The inclusion of a thermal break 29 made of an insulating material such as rubber will reduce the thermal conductivity of the window frame. Thermal break 29 makes it necessary to alter the geometry of the inventive concept. Offset base plate 180 is attached to window frame 20 with guide post 61 and guide post 63 and mounting attachments not shown. Elevator attachment 10 and distal end 13 are shown protruding through threaded insert 99. The combination of elevator attachment 10, guide post 61, and guide post 63 dictate the geometry and the travel of clip 90 relative to frame 20 and the offset embodiment of the inventive concept operate in the same manner as the embodiment shown in FIG. 8.

FIG. 14 shows the context of the inventive concept. Window frame 20 is shown within a window opening of building 250.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A device for attaching a window frame to a window opening, comprising:
a window frame having an opening;
a clip having a threaded opening, the clip positioned adjacent to the window frame; and
an elevator attachment positioned through the window frame opening that threadedly engages the threaded opening,
wherein the elevator attachment is configured to adjust a distance between the clip and the window frame by turning the elevator attachment.

2. The device of claim 1, wherein the elevator attachment is a threaded fastener.

3. A device for attaching a window frame to a window opening comprising:
a window frame having an access hole;
a clip having a threaded opening, the clip positioned adjacent to the window frame;
a base plate married to the window frame, the base plate having an opening, wherein an elevator attachment passes through the opening; and
the elevator attachment accessible through the access hole in the window frame that threadedly engages the threaded opening,
wherein the elevator attachment is configured so that the distance of the clip to the base plate is adjusted when the elevator attachment is turned.

4. The device as recited in claim 3, wherein the opening in the base plate is smooth.

5. The device of claim 3, wherein the opening in the base plate further comprises a bevel.

6. The device of claim 3, wherein the clip comprises a front centering angle and a rear centering angle.

7. The device as recited in claim 3, further comprising a track.

8. The device as recited in claim 3, wherein the elevator attachment is a threaded fastener.

9. A device for attaching a window frame to a building structure, comprising:
a window frame having an access hole;
a base plate having a base plate smooth opening, and positioned adjacent to the window frame;
an angled clip having a threaded opening, the clip positioned adjacent to the base plate;
an elevator attachment positioned through the base plate smooth opening to threadedly engage the threaded opening in the angled clip,
an angled track connected to the building structure;
a guide post; and
a mounting screw,
wherein the guide post passes through an opening in the angled clip to friction fit into a second opening in the base plate,
wherein the mounting screw passes through the window frame to engage an interior threaded distal end of the guide post and secures the base plate to the window frame and retains the angled clip about the guide post,
wherein the elevator attachment is accessible through the access hole and configured such that the distance between the angled clip and the window frame is adjusted when the elevator attachment is turned while the angled clip is retained on the guide post to engage an interior of the angled track.

10. The device of claim 9, wherein the angled clip further comprises a front centering angle and a rear centering angle, the angled track further comprises a central ridge.

11. A method for attaching a window frame positioned inside a structure to a window opening, the method comprising:
providing:
a window frame;
a clip having a threaded opening, the clip positioned adjacent to the window frame; and
an elevator attachment positioned through the window frame that threadedly engages the threaded opening,
wherein the elevator attachment is configured to adjust a distance between the clip and the window frame by turning the elevator attachment; and
turning the elevator attachment to adjust the distance.

12. The method as in claim 11 wherein the structure is a wall.

13. The method as in claim 12 wherein the structure is a building exterior wall.
